(19) United States
(12) Patent Application Publication
(10) Pub. No.: US 2006/0257440 A1
(43) Pub. Date: Nov. 16, 2006

(54) Insecticidal composition

(76) Inventors: Makoto Asai, Kanagawa (JP); Rieko Nakamura, Shizuoka-ken (JP)

Correspondence Address: LAHIVE & COCKFIELD, 28 STATE STREET, BOSTON, MA, 02109, US

(21) Appl. No.: 10/557,274

(22) PCT Filed: May 18, 2004
(86) PCT No.: PCT/JP04/07037

§ 371 Date: Nov. 17, 2005

(30) Foreign Application Priority Data
May 19, 2003 (JP) 2003-140022
Aug. 20, 2003 (JP) 2003-296189

(51) Int. Cl. A01N 43/40; A01N 65/00; A01N 25/00

(52) U.S. Cl. 424/405; 424/731; 514/355

(57) ABSTRACT

The present invention relates to an insecticidal composition including (1) a chloronicotinyl compound as an insecticidally active ingredient, (2) an organic solvent which is a mixed solvent comprising dimethyl sulfoxide and either dimethylacetamide or γ-butyrolactone or is a ternary solvent comprising the mixed solvent and N-methylpyrrolidone added thereto, and (3) a castor oil surfactant or a propylene oxide/ethylene oxide block copolymer surfactant. The composition is less irritating to the eyes. It is less apt to exhibit crystal preciptation even at low temperatures and evenly dissolves in water. It has excellent biological activity.

### TECHNICAL FIELD

The present invention relates to a water-soluble solution which evenly dissolves in water and exhibites excellent insecticidal activity, and particularly relates to a water-soluble solution containing as its active ingredient a chloronicotinyl compound such as acetamiprid.

### BACKGROUND ART

Although emulsions, wettable powders, flowable agents, or the like can be raised among agricultural chemical formulations as examples of formulations that are to be diluted with water before spraying, a method for formulation of a water-soluble agent in which an active ingredient is dissolved in a polar solvent which readily dissolves in water is preferred due to easy handling thereof. As a water-soluble agent containing a chloronicotinyl compound as a bioactive ingredient, Japanese Laid-Open Patent Application No. Hei 8-92091, for example, discloses a formulation in which a chloronicotinyl insecticide such as imidacloprid is formulated with a solvent such as ethanol, butanol, glycerol, hydrocarbons, polyethylene glycol, N-methylpyrrolidone, or the like in a concentrated solution which is to be diluted before application, and more specifically discloses a water-soluble concentrated (SL) formulation using imidacloprid with a natural emulsifier based on an alkylaryl polyglycol ether or sodium diisooctyl sulfosuccinate as a surfactant, and dimethyl sulfoxide and isopropanol as polar solvents.

Moreover, Published Japanese Translation No. 2001-50665 of PCT International Publication discloses as a formulation of a compound having insecticidal activity a water-soluble agent using a nonyl phenol ethylene oxide concentrated solution, and a concentrated solution of N-methylpyrrolidone or tristyryl phenol ethylene oxide, 70% W/W solution of calcium dodecylbenzene sulfonate, N-methylpyrrolidone, and Solvesso.

However, the above-mentioned compositions are insufficiently stable at low temperature and have problems with the handling thereof in a state of concentrated solution, and the activity thereof is also insufficient.

### DISCLOSURE OF THE INVENTION

The present invention has as its object to provide a water-soluble solution of chloronicotinyl insecticide which puts less burden on the environment and has excellent effects.

As a result of conducting extensive studies to solve the aforementioned problems, the inventors of the present invention found that the aforementioned problems could be solved by using an organic solvent which is a mixed solvent containing dimethyl sulfoxide and either dimethylacetamide or γ-butyrolactone, and additionally by combining a particular surfactant, thereby leading to completion of the present invention.

Specifically, the present invention relates to the following:
[1] a liquid insecticidal composition characterized by comprising: (1) a chloronicotinyl compound; (2) a solvent comprsing dimethyl sulfoxide and either dimethylacetamide or γ-butyrolactone; and (3) a surfactant;
[2] a liquid insecticidal composition according to [1] characterized in that the surfactant is a castor oil surfactant or a propylene oxide/ethylene oxide block copolymer surfactant;
[3] a liquid insecticidal composition according to [1] or [2] characterized in that the chloronicotinyl compound is acetamiprid;
[4] a liquid insecticidal composition according to any one of [1] to [3] characterized in that the chloronicotinyl compound (1) is contained in an amount of 1.5 to 40% by weight, the solvent (2) is contained in an amount of 59.9 to 98.4% by weight, and the surfactant (3) is contained in an amount of 0.1 to 10% by weight;
[5] a liquid insecticidal composition according to any one of [1] to [4] characterized in that the weight ratio of dimethyl sulfoxide to either dimethylacetamide or γ-butyrolactone in the solvent is in the range of 10:90 to 90:10; and
[6] a liquid insecticidal composition according to any one of [1] to [5] characterized in that the solvent comprises 2 to 40% by weight of N-methylpyrrolidone relative to the whole solvent.

The chloronicotinyl compound to be used in the present invention is not particularly limited, provided that it has a chloronicotinyl group or exhibits similar bioactivity, and the following compounds can be specifically raised as examples.

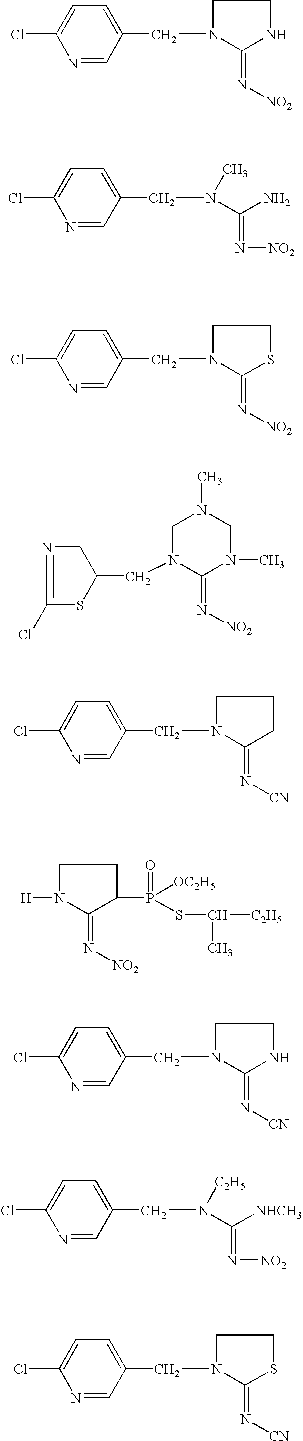

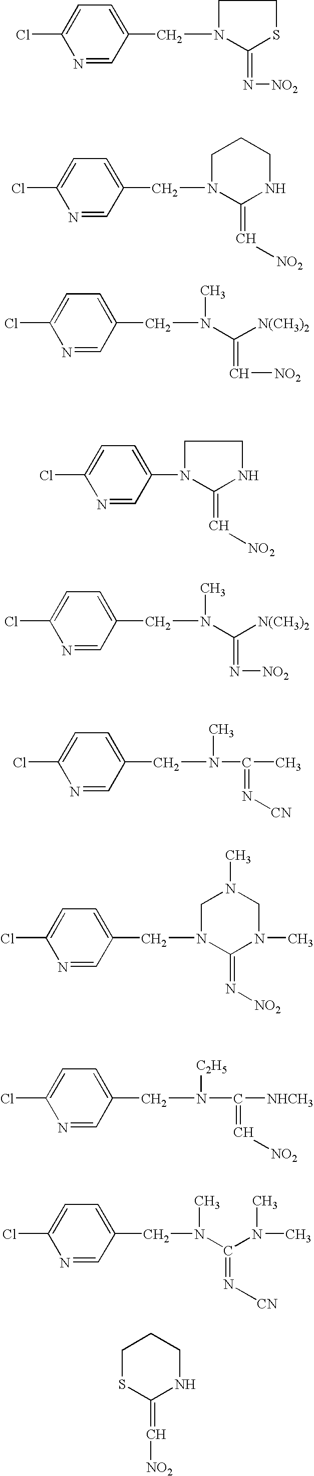

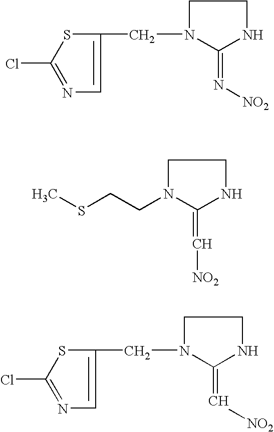

Among them, acetamiprid is particularly preferable.

The solvent usable in the present invention is a mixed solvent containing dimethyl sulfoxide and at least one selected from the group consisting of dimethylacetamide and γ-butyrolactone. Although the mixing ratio thereof is not particularly limited, provided that it is within a range which enables the chloronicotinyl compound to be dissolved, it is specifically preferable that the ratio by weight of dimethyl sulfoxide to at least one selected from the group consisting of dimethylacetamide and γ-butyrolactone be in a range of 10:90 to 90:10. Although other solvents such as ethanol, butanol, benzyl alcohol, glycerol, hydrocarbons, propylene glycol, polyethylene glycol, N-methylpyrrolidone, or the like may be optionally added, if needed, N-methylpyrrolidone is preferably used to improve the stability of the chloronicotinyl compound at low temperature. Although the content of N-methylpyrrolidone is not particularly limited, it is preferably within a range of 2 to 40% by weight of the whole solvent in view of handling convenience.

Specific examples of the surfactant usable in the present invention include ionic or nonionic emulsions, dispersants, wetting agents, and mixtures thereof. Particular examples thereof include salts of polyacrylic acid, salts of lignosulfonic acid, salts of phenolsulfonic acid or naphthalenesulfonic acid, condensed polymers of ethylene oxide and fatty alcohol or fatty acid, fatty acid ester, or fatty acid amino, substituted phenols (particularly alkylphenol or arylphenol), sulfosuccinate ester, taurine derivatives (particularly alkyltaurate), phosphoric esters of condensed polymers of alcohol or phenol and ethylene oxide, esters of fatty acid and polyol, sulfates, derivatives having a functional group of sulfonate or phosphate of the above-mentioned compound, and the like. Preferable examples thereof include castor oil surfactants, and propylene oxide/ethylene oxide block copolymer surfactants.

Although the mixing ratio of the chloronicotinyl compound, the solvent and the surfactant in the liquid insecticidal composition of the present invention is not particularly limited, it is specifically preferable that the chloronicotinyl compound be contained in an amount of 1.5 to 40% by weight, the solvent be contained in an amount of 59.9 to 98.4% by weight, and the surfactant be contained in an amount of 0.1 to 10% by weight.

### BEST MODE FOR CARRYING OUT THE INVENTION

Although the following provides a specific explanation of effects of the present invention through examples, the present invention is not limited to these examples.

### Example 1

20 g of acetamiprid was dissolved in a mixed solvent containing 37.5 g of dimethylacetamide and 37.5 g of dimethyl sulfoxide, and 5 g of polyoxyethylene castor oil (HLB 11.7) was further dissolved in the mixture as a surfactant to obtain a uniform solution.

### Example 2

20 g of acetamiprid was dissolved in a mixed solvent containg 37.5 g of γ-butyrolactone and 37.5 g of dimethyl sulfoxide, and 5 g of polyoxyethylene hydrogenated castor oil (HLB 10.8) was further dissolved in the mixture as a surfactant to obtain a uniform solution.

### Example 3

20 g of acetamiprid was dissolved in a mixed solvent containing 37.5 g of γ-butyrolactone and 41.5 g of dimethyl sulfoxide, and 1 g of PO/EO block copolymer (HLB 12 to 18: manufactured by BASF under the name of Pluronic PE 6400) was further dissolved in the mixture as a surfactant to obtain a uniform solution.

### Example 4

20 g of imidacloprid was dissolved in a mixed solvent containing 37.5 g of dimethylacetamide and 37.5 g of dimethyl sulfoxide, and 5 g of polyoxyethylene castor oil was further dissolved in the mixture as a surfactant to obtain a uniform solution.

### Example 5

20 g of acetamiprid was dissolved in a mixed solvent containing 27.5 g of dimethylacetamide, 37.5 g of dimethyl sulfoxide, and 10 g of N-methylpyrrolidone, and 5 g of polyoxyethylene castor oil (HLB 11.7) was further dissolved in the mixture as a surfactant to obtain a uniform solution.

### Example 6

20 g of acetamiprid was dissolved in a mixed solvent containing 27.5 g of γ-butyrolactone, 37.5 g of dimethyl sulfoxide, and 10 g of N-methylpyrrolidone, and 5 g of polyoxyethylene hardened castor oil (HLB 10.8) was further dissolved in the mixture as a surfactant to obtain a uniform solution.

### Comparative Example 1

20 g of acetamiprid was dissolved in 75 g of N-methylpyrrolidone, and 5 g of polyoxyethylene nonylphenyl ether (HLB 12.9) was further dissolved in the mixture as a surfactant to obtain a uniform solution.

### Comparative Example 2

7 g of acetamiprid was dissolved in 83 g of N-methylpyrrolidone, and 10 g of polyoxyethylene nonylphenyl ether (HLB 12.9) was further dissolved in the mixture as a surfactant to obtain a uniform solution.

### Comparative Example 3

7 g of imidacloprid was dissolved in 83 g of N-methylpyrrolidone, and polyoxyethylene nonylphenyl ether (HLB 12.9) was further dissolved in the mixture as a surfactant to obtain a uniform solution.

### Test Example 1 (Eye Irritancy Test of Undiluted Solution of Formulation Using Rabbit)

(Method)

0.1 ml of an undiluted solution of each formulation was dropped on the right eye of normal rabbit, and the rabbit was observed 1 hour, 24, 48, and 72 hours after exposure. When the irritancy was continued, the rabbit was observed every day, and until 21 days after exposure. The results are shown in Table 1.

TABLE 1

| | Ex. 1 | Ex. 2 | Ex. 3 | Ex. 4 | Ex. 5 | Ex. 6 | C. Ex. 1 | C. Ex. 2 | C. Ex. 3 |
|---|---|---|---|---|---|---|---|---|---|
| Degree of | Weak | Weak | Weak | Weak | Medium | Medium | Strong | Strong | Strong |
| eye | | | | | | | | | |
| irritancy | | | | | | | | | |

When N-methylpyrrolidone was used (Comparative Examples 1 to 3), eye irritancy was strong. When the ratio of N-methylpyrrolidone decreased (Examples 5 and 6), eye irritancy decreased, and when N-methylpyrrolidone was not used (Examples 1 to 4), eye irritancy significantly decreased.

Test Example 2 (Crystal Precipitation Test of 20% Acetamiprid Solution at Low Temperature)

(Method)

This test was carried out in accordance with CIPAC MT 39.1. After cooling each solution at −5° C. and −10° C. for one day, the presence of crystals was visually observed. The results are shown in Table 2.

TABLE 2

| | Ex. 1 | Ex. 2 | Ex. 3 | Ex. 5 | Ex. 6 | C. Ex. 1 |
|---|---|---|---|---|---|---|
| Crystals | Absent | Absent | Absent | Absent | Absent | Absent |
| precipitated | | | | | | |
| at −5° C. | | | | | | |
| Crystals | Present | Present | Present | Absent | Absent | Absent |
| precipitated | | | | | | |
| at −10° C. | | | | | | |

When the mixed solvent containing dimethyl sulfoxide and dimethylacetamide (Example 1) or the mixed solvent containing dimethyl sulfoxide and γ-butyrolactone (Examples 2 and 3) were used, crystals were precipitated at −10° C. However, when N-methylpyrrolidone was added to the mixed solvent (Examples 5 and 6), the solubility of acetamiprid increased and the precipitation of crystals could be suppressed.

### Test Example 3 (Biological Evaluation Test: Efficacy Test for Cucumber Thrips)

Subject crop: Cucumber (Tsubasa, 2-leaf age)

Place in which test was carried out: Pot in a green house

Spraying method: Spraying a sufficient amount of the solution that diluted with water and containing 100 ppm of active component.

Investigation method: The number of larvae existing on the second leaf was counted.

The test was carried out twice, and the total numbers of larvae that were counted are shown in Table 3.

TABLE 3
Efficacy test for cucumber thrips

| | | | | Number of | Number of |
|---|---|---|---|---|---|
| | | Number of | Number of | larvae | larvae |
| | | larvae | larvae | existing | existing |
| | Concentration | existing | existing 8 | 11 | 15 |
| | of sprayed | before | days after | days after | days after |
| | solution | spraying | spraying | spraying | spraying |
| Ex. 1 | Acetamiprid | 0 | 0 | 7 | 54 |
| | 100 ppm | | | | |
| Ex. 2 | Acetamiprid | 0 | 1 | 15 | 44 |
| | 100 ppm | | | | |
| Ex. 3 | Acetamiprid | 0 | 0 | 6 | 50 |
| | 100 ppm | | | | |
| Ex. 4 | Imidacloprid | 0 | 1 | 8 | 79 |
| | 100 ppm | | | | |
| C. Ex. 2 | Acetamiprid | 0 | 5 | 27 | 92 |
| | 100 ppm | | | | |
| C. Ex. 3 | Imidacloprid | 0 | 3 | 62 | 297 |
| | 100 ppm | | | | |
| Control | — | 0 | 22 | 163 | 229 |

When the results of Comparative Examples 2 and 3 are compared with the results of Examples 1 to 4, it is apparent that bioactivity is significantly increased in Examples.

### INDUSTRIAL APPLICABILITY

As described above, the liquid insecticidal composition of the present invention is excellent in stability at low temperature and also improved in insecticidal activity and safety. Since the chloronicotinyl compound exhibits excellent activity as an insecticide, when it is formulated to be a water-soluble agent, it becomes applicable to novel application methods as well as becoming easy to use. Accordingly, it can be stated that the industrial value of the present invention is high.

1. A liquid insecticidal composition comprising:
(1) a chloronicotinyl compound;
(2) a solvent comprising dimethyl sulfoxide and either dimethylacetamide or γ-butyrolactone; and
(3) a surfactant.

2. A liquid insecticidal composition according to claim 1, wherein the surfactant is a castor oil surfactant or a propylene oxide/ethylene oxide block copolymer surfactant.

3. A liquid insecticidal composition according to claim 1, wherein the chloronicotinyl compound is acetamiprid.

4. A liquid insecticidal composition according to claim 1, wherein the chloronicotinyl compound is contained in an amount of 1.5 to 40% by weight, the solvent is contained in an amount of 59.9 to 98.4% by weight, and the surfactant is contained in an amount of 0.1 to 10% by weight.

5. A liquid insecticidal composition according to claim 1, wherein the ratio of dimethyl sulfoxide to either dimethylacetamide or γ-butyrolactone in the solvent is in a range of 10:90 to 90:10.

6. A liquid insecticidal composition according to claim 1, wherein the solvent comprises 2 to 40% by weight of N-methylpyrrolidone relative to the whole solvent.
